(19) United States
(12) Patent Application Publication
(10) Pub. No.: US 2007/0201600 A1
(43) Pub. Date: Aug. 30, 2007

(54) System For Controlling A Shell-Type Nuclear Reactor And A Two-Position Switch For The Passive Protection Thereof

(76) Inventor: Mikhail Yurievich Kudryavtsev, Lyublinskaya (RU)

Correspondence Address: PATENTTM.US, P. O. BOX 82788, PORTLAND, OR, 97282-0788, US

(21) Appl. No.: 10/599,828

(22) PCT Filed: Apr. 5, 2005
(86) PCT No.: PCT/RU05/00170

§ 371 Date: Oct. 11, 2006

(30) Foreign Application Priority Data
Sep. 3, 2004 (RU) 2004126494

(51) Int. Cl. G21C 7/36

(52) U.S. Cl. 376/217

(57) ABSTRACT

The invention relates to nuclear reactor control systems. The inventive nuclear reactor control system comprises a set of technical means for limiting an increment rate in reactivity by operating devices and for automatically stopping a nuclear reactor, wherein said set of technical means comprises actuators provided with drives and connections which transmit the motion from the actuator drives to the operating devices which are disposed outside of the reactor body. The reactor body comprises fixed elements arranged thereinside for engaging and disengaging the operating devices in such a way that said operating devices are movable after disengagement towards a decrement in reactivity only. Each operating device is provided with at least two actuators one of which is common for all operating devices or for a group of operating devices and the other actuator is individual for each operating device and disengages said device from the fixed element in any order with respect to other operating devices. The set of technical means is provided with two-position switches which are disposed inside the reactor body and have two fixed positions depending on the position of the switch control element corresponding to a critical value attained by one of parameters determining the normal operation limits of the reactor.

### FIELD OF THE INVENTION

This invention relates to control systems for nuclear reactors.

### PRIOR ART

A nuclear reactor is hazardous in that it may cause harm to population, the environment and servicing personnel. The state regulation of the activities associated with nuclear reactors establishes admissible and inadmissible levels of nuclear reactor detrimental effects. These levels correspond to admissible and inadmissible values of the parameters defining the nuclear reactor hazard. The safe operation limits are the boundary between the admissible and inadmissible values of these parameters. In accordance with the technical regulations, nuclear reactor projects establish operation limits and conditions corresponding to the normal operation and provide for technical means that preclude reaching the safe operation limits in cases where the normal operation mode is violated, including automatic means for shut-down of reactors.

The basis for controlling a nuclear reactor is the control of reactivity determining changes in the nuclear reactor power: positive reactivity leads to a power increment and negative reactivity to a power decrement. An increase of positive reactivity over a certain value results in the loss of the nuclear reactor control, therefore, the technical regulations require that the admissible reactivity level and the admissible rate of reactivity increment may not be exceeded. The compliance with these requirements of the technical regulations is ensured by technical means provided for in nuclear reactor projects. In order to preclude reaching the safe operation limits in cases where the normal mode of operation is violated, the automatic means for shut-down of a nuclear reactor ensure a decrement rate in reactivity that is far more higher than the admissible increment rate in reactivity. A controlled change in reactivity may be ensured by moving operating devices influencing reactivity. The most common are operating devices in the form of rods moved longitudinally. A shell-type nuclear reactor comprises operating devices arranged within the reactor shell.

A system of nuclear reactor protection is known that comprises the upper control rod and the lower control rod which are interconnected by a flexible element thrown over the rotation unit for the purpose of ensuring their opposing motion, and a retainer, wherein the upper rod weight being greater than the lower rod weight (see Inventor's Certificate SU #1657020, G 21 C 7/08, 20.05.1996).

The said system enables to unclamp the upper rod in emergency situations, which is lowered into the core under the gravity force, and the lower rod is raised toward the upper rod. But the system does not enable to shut down a nuclear reactor in cases of wrong actions of the nuclear reactor personnel, which narrows the field of use of the system.

The closest to this invention as to the technical subject-matter and the achieved result is a control system for a nuclear reactor, which comprises a selection unit, a monitoring unit and a control unit for operating devices that are the control rods, wherein the said selection device provides for a selected procedure of moving the operating devices at each preset control action and is connected to the control unit for the operating devices for the purpose of transmitting selection signals associated in each case with the selected procedure of actions, wherein the monitoring unit monitors, with due regard to the structural features of the core and the operating devices—control rods, in particular neighboring connections of the control rods, associated with the corresponding procedure of actions, the selection signals for admissibility, and, if they are admissible, transmits a signal of permission to the control unit for the rods, and the control unit for the rods induces movement of the control rods according to selection signals (see U.S. Pat. No. 58,188,926, G 21 C 7/12, 06.10.1998).

The said system enables to prevent an emergency at a nuclear reactor in a case of an accidental error of the reactor servicing personnel. But the system does not enable to preclude conscious actions of the personnel aimed at changing the reactor operation mode toward an increment in reactivity, which may occur, for example, in a case of capturing personnel's relatives by a terrorist group that consciously compels the nuclear reactor personnel to transfer the reactor to operation in the reactivity increment mode resulting in subsequent loss of control over the reactor.

Subversive control of a nuclear reactor, e.g., in the result of intrusion of a terrorist group in accommodation places for the personnel, is understood as a qualified action (for example, that of the personnel coerced by terrorists by capturing relatives) on the control means of a nuclear reactor, which is aimed at reaching inadmissible values of parameters defining the nuclear reactor hazard (i.e., violating the safe operation limits). In the conditions of a guarded facility at which a nuclear reactor is operated the facility guards will hinder subversive control if clear evidence of such control exists. Therefore, duration of subversive control of a nuclear reactor is limited to a time period until such evidence appears. If some admitting persons from a work shift participate in subversive activities, then clear evidence for the guards may be reports from personnel members and signs that are identified by means of guard observation, namely: broken walls, doors, windows, hatches, presence of fire, smoke, vapor or high radiation in premises, inadmissible changes in temperature or humidity in premises, damage to security systems.

Most probable that subversive control of a nuclear reactor will be identified upon reporting by personnel when a new shift comes to work. Terrorist coercion of the whole personnel to subversive control of a nuclear reactor is, in essence, an attack at personnel accommodation places and should be stopped by the facility external guards. Terrorist coercion of a personnel shift to subversive control of a nuclear reactor should be considered as a single failure of the facility external protection system. According to the logic accepted in technical regulations, the safety of a nuclear reactor should be ensured both at a source event and at a single failure independent of the respective source event. Following this logic, it is possible that two successive personnel shifts may be coerced to subversive control of a nuclear reactor (coercion of one shift forms a source event, coercion of the next shift forms an additional single failure of the protection system). Taking the common 8-hour period of a work shift, it means 16-hour duration of subversive control of a nuclear reactor.

The most sensitive to subversive control of a nuclear reactor are the elements of the control system that are located outside the shell of a nuclear reactor, because their location allows a quicker (compared to the work shift duration) change. At the same time, it is the control system elements located outside the nuclear reactor shell that ensure limitation of the reactivity level and an increment rate in reactivity while simultaneously ensuring a high decrement rate in reactivity in the known analogous solutions.

The known devices of direct-action (passive) emergency protection (shutdown) of a nuclear reactor, which do not use an external monitoring and control circuit and operating devices are set in motion toward a decrement in reactivity after devices, like two-position switches, act, wherein such switches have two fixed states depending on a position of the switch control element relative to the critical position corresponding the critical value reached by one of the parameters defining the limits of the reactor safe operation: a neutron flux, and/or a temperature of the reactor coolant, and/or a flow rate of the reactor coolant, and/or a pressure of the reactor coolant (see magazine “Atomnaya Tekhnika za Rubezhom”, #1, 1988, p. 10-16). These devices do not perform the function of delimiting an increment rate in reactivity when simultaneously ensuring a high decrement rate in reactivity; therefore, in a case of subversive control of a nuclear reactor they should act at a high increment rate in reactivity. At the same time, the two-position switch control elements of such devices are not directly connected to the fuel rods of a reactor, only variants are known that comprise control elements connected to additional fuel rods included into the composition of devices, wherein such additional fuel rods are different from the reactor fuel rods by their size and structure. Since the technical regulations determine the limits of the nuclear reactor safe operation according to a number and defect size of the reactor fuel rods, the main way of subversive violation of the safe operation limits is to destruct the reactor fuel rods in the result of exceeding the fuel rod admissible temperature. The operating speed and sensitivity of two-position switch control elements during determining a temperature of the reactor fuel rods when the control elements are not directly connected to the reactor fuel rods, are not sufficient for ensuring that the safe operation limits will not be reached at a high increment rate in reactivity when between the fuel rods and the coolant a great temperature difference exists. Devices acting according to a flow rate of the reactor coolant are also disadvantageous in that the coolant may begin boiling before operating devices are set in motion and that a false acting may occur if the coolant flow is stopped for a short time.

Thus, automatic transfer of the nuclear reactor operation into the mode of a decrement in reactivity with a subsequent shutdown of a nuclear reactor without violating the safe operation limits in a case where the normal operation is violated for a period of two work shifts, i.e., for 16 hours, during subversive control of a nuclear reactor is an extremely important task that is not solved in the known devices.

### SUMMARY OF THE INVENTION

The technical effect, to which the present invention is aimed, is to improve reliability of the nuclear reactor operation in the safe mode by precluding a possibility of transferring the nuclear reactor operation into a mode violating the safe operation limits during 16-hour period of subversive control of a nuclear reactor.

The said technical effect is achieved owing to that the control system for a shell-type nuclear reactor comprises a set of technical means intended to delimit an increment rate in reactivity by operating devices and to automatically shut down a nuclear reactor, wherein the said set of technical means comprises actuators provided with motors and connections transmitting motion from the actuator motors to operating devices, the latter being disposed within the reactor shell, and also within the reactor shell fixed elements are arranged which are intended for engaging and disengaging the operating devices with the possibility of moving the operating devices by the resultant of the forces continuously acting on the operating devices after disengagement toward a decrement in reactivity only, each operating device is provided with at least two actuators, one of which is common for all the operating devices or for a group of operating devices and moves the operating devices toward an increment in reactivity up to engagement with the fixed elements only alternatively, one by one, after its motor connection is engaged with a selected operating device, and the other actuator is individual for each operating device and disengages that operating device from the said fixed element in any order relative to the other operating devices by means of disengaging its motor connection from the element engaging the operating device with the fixed element, the set of technical means is provided with two-position switches disposed within the reactor shell and having two fixed states depending on the position of the switch control element relative to a critical position corresponding to a critical value reached by one of the parameters defining the limits of the reactor safe operation, the connections of the individual actuator motors are provided with controlled disengagement elements, for example in the form of coupling elements, disposed within the reactor shell with the possibility of disengaging the connections for the purpose of moving the operating devices toward a decrement in reactivity when the two-position switches are in the state corresponding to critical values reached by the parameters defining the reactor safe operation limits.

In this system the impossibility of exceeding an admissible increment rate of reactivity is ensured by a limited number of common actuators and the limited efficiency of the operating devices simultaneously moved by the actuators.

In a case of subversive control of a nuclear reactor actions on the actuators that are exerted from the outside of the reactor shell may be aimed at violating the safe operation limits, including a case of moving the operating devices at a maximum rate toward an increment in reactivity and at precluding movements of the operating devices toward a decrement in reactivity. According to this invention, disengagement of the connections between individual actuator motors and the elements engaging the operating devices with the reactor fixed elements ensures the action priority of the individual actuators of the parameters defining the safe operation limits relative to actions exerted from the outside of the nuclear reactor shell. A high decrement rate in reactivity is ensured by a much greater number (compared to the common motors) of the individual motors and by much higher efficiency of all the operating devices compared to the efficiency of the operating devices that may be simultaneously moved by the common motors toward an increment in reactivity. Due to a general decrement in reactivity a nuclear reactor may be automatically shut down without violating the safe operation limits in cases of violating the normal operation at subversive control of the nuclear reactor.

Thus, the new, compared to those in analogous solutions, distribution of the actuator functions, structure and operation of the connections between the operating devices and the actuator motors and use of the parameters within the reactor shell all ensure limitation of an increment rate in reactivity by the operating devices and automatic shutdown of the nuclear reactor only with the use of the elements disposed within the reactor shell. Therefore, in order to achieve the objective of subversive control it is necessary to open the reactor shell and disable the said elements.

In order to avoid involvement of the guards, the reactor should be stopped before opening and cooled from the operating temperature (that of most shell-type reactors is app. 320° C.) to a temperature that does not causes inadmissible parameters of the premises condition (about 70° C.).

The normal rate of cooling shell-type reactors (by 15° C. in an hour) may not be exceeded which is ensured by limiting the number and capacity of the pumps and heat exchangers for normal cooling. Cooling from 320° C. to 70° C. at the normal rate (15° C. in an hour) will require more than 16 hours, that is, during 16-hour period of subversive control of a nuclear reactor the fuel rods disposed within the reactor shell will be inaccessible for the personal, and the subversive control objective will not be achieved.

The physical processes accompanying cooling of shell-type nuclear reactors at a high rate (exit of hot vapor into the atmosphere or process containers, a sharp increase in the temperature and/or humidity of the premises, inadmissible deformations of pipelines) are signs obvious for the guards, which require involvement. Therefore, rapid cooling of a nuclear reactor will result in involvement of the guards and stoppage of the nuclear reactor subversive control before opening the reactor shell.

In order to preclude a possibility of subversive control of a nuclear reactor during maintenance the connections between the common actuator motors and the operating devices are provided with disengaging elements disposed within the reactor shell near the shell connector and made, e.g., in the form of coupling elements which are capable of disengaging the connections if the connector at the reactor shell is disconnected. The arrangement of a disengaging element in close proximity to the connector enables technically easy monitoring the condition of the disengaging element with the guard observation means.

In order to preclude the possibility, which may arise during subversive control of a nuclear reactor at the maintenance period, of disabling the elements that are disposed within the reactor shell and ensure an automatic shutdown of the reactor, the two-position switch control elements are made with the possibility of moving the control elements by a common actuator after its motor connection engages a selected control element only to the side corresponding to an induced movement of the operating devices toward a decrement in reactivity. By alternatively moving the control elements in the process of normal operation (after a maintenance period as well) it is possible to alternatively check the ability of the two-position switches to set the operating devices, as connected thereto, in motion toward a decrement in reactivity if any parameters defining the limits of the reactor safe operation reach their critical values.

Thus, the technical effect may be achieved that ensures improved reliability of the safe operation of a nuclear reactor by precluding the possibility of transferring the nuclear reactor to an operation mode violating the safe operation limits during a 16-hour period of subversive control of the nuclear reactor.

The operating devices may be made in the form of rods influencing reactivity and being capable of longitudinally moving from one extreme position to the other without stopping in an intermediate position and without monitoring intermediate positions of the operating devices, the influence of each individual operating device on reactivity being small.

Small influence on reactivity by each individual operating device means that simultaneous movement of the operating devices to their full travel by all the common actuators available in a nuclear reactor does not result in exceeding the reactivity increment step permitted by the technical regulations during the minimum possible time of moving the operating devices to their full travel by the common actuators. And due to a great number of low efficiency rods any one of them is in one of the extreme positions for a long time. It is difficult to obtain such effect in the analogous solutions, since each operating device has its own, rather complicated actuator, and the required number of actuators may not be arranged in real designs. But it is possible in this invention, since the number of common actuators is not high, and the simple functions of an individual actuator enable to use a solenoid of small size as its motor, and due to this to arrange all the actuators in a real design. Thus, a supplemental technical effect may be achieved that consists in prevention of prolonged longitudinal disturbances of a neutron field, which are caused by the operating devices made in the form of longitudinally moved rods in intermediate positions. The stability of the neutron field form in the operation process improves safety and efficiency of a nuclear reactor.

Fail-safe movement of an operating device, being a constituent of the nuclear reactor reliability, may be further improved by decreasing the number of mechanical elements connected to an operating device during its movement. For this purpose the operating devices may be arranged relative to the said fixed elements of the reactor with the possibility of moving the operating devices under the gravity force or the buoyancy force toward a decrement in reactivity only after being disengaged from the said fixed elements of a reactor if the operating devices are not engaged with the connection of the common actuator motor. Also for this purpose an engaging element for the connection between a common actuator motor and an operating device may be made in the form of a reactor coolant with the possibility of setting such coolant in control motion by a common actuator for moving the operating device toward an increment in reactivity up to its engagement with a fixed element of the reactor.

The technical regulations define the safe operation limits of a nuclear reactor according to number and size of defects in fuel rods. The integrity of the fuel rods is influenced by a fuel rod temperature, a corrosiveness of the nuclear reactor coolant and mechanical loads. As the design mechanical loads do not damage fuel rods, and the location of the fuel rods within the reactor shell makes subversive increment in mechanical loads on the fuel roads practically impossible, real ways of subversively damaging fuel rods are a raise in the fuel rod temperature and an increase in the corrosiveness of a reactor coolant. In order to preclude the possibility of subversively damaging the fuel rods, a control element is made so as to enable transition of a two-position switch from one state to the other (acting) if the following parameters reach their critical values: thermal elongation of fuel rods of a nuclear reactor, and/or density of the reactor coolant, and/or corrosiveness of the reactor coolant. A thermal elongation of a fuel rod characterizes the fuel rod temperature, and a density of a coolant characterizes the intensity of heat transfer from a fuel rod, i.e., dependence of the fuel rod temperature on the heat generation in it. This making of a two-position switch ensures its high operating speed and sensitivity after the fuel rod temperature reaches its critical value, enables to begin lowering reactivity at a coolant loss, i.e., prevent the fuel rods from overheating, as well as permits to obtain a new technical effect, namely: to improve the safety of a nuclear reactor when the corrosiveness of the reactor coolant is increased.

Since heat is generated in the fuel rods, which is transferred to the coolant, the fuel rod temperature is higher than the coolant temperature, and a temperature difference increases with the speed of fuel rod heating. Therefore, the control element of a two-position switch, which acts after the fuel rod thermal elongation reaches its critical value, may be made with the possibility of changing its position depending on a difference between the fuel rod length and the length of a reactor element having the temperature equal to that of the reactor coolant and made either of the material used for making the fuel rod casing or of a material having the thermal elongation coefficient lesser than that of the fuel rod casing. In this case a difference between the thermal elongation of the fuel rod and that of the nuclear reactor element having a temperature equal to that of the coolant characterizes both the fuel rod temperature and its speed of heating. If the said difference exceeds a pre-set value, actions of the corresponding two-position switches will lead to movement of the operating devices toward a decrement in reactivity.

The control element of a two-position switch, in order it may act when the reactor coolant reaches its critical density, may be connected to a float located in a chamber filled with the reactor coolant having a temperature and a pressure corresponding to those of the coolant exiting the reactor core. If the density of the reactor coolant falls below a pre-set value, the float in the chamber goes down, and the corresponding two-position switches will act, causing movement of the operating devices toward a decrement in reactivity.

The control element of a two-position switch, in order it may act when the reactor coolant reaches its critical corrosiveness value, may be connected to an element arranged in the reactor coolant and made of the material used for making the fuel rod casing, wherein the said element may be destructed under a set load due to corrosive wear. If the corrosiveness of the reactor coolant exceeds a pre-set value within a pre-set time, destruction of the elements made of the material used for making the fuel rod casing will move the control elements, and the action of the corresponding two-position switches will cause movement of the operating devices toward a decrement in reactivity.

### BRIEF DESCRIPTION OF THE DRAWINGS

FIG. 1 schematically shows the control system for a shell-type nuclear reactor.

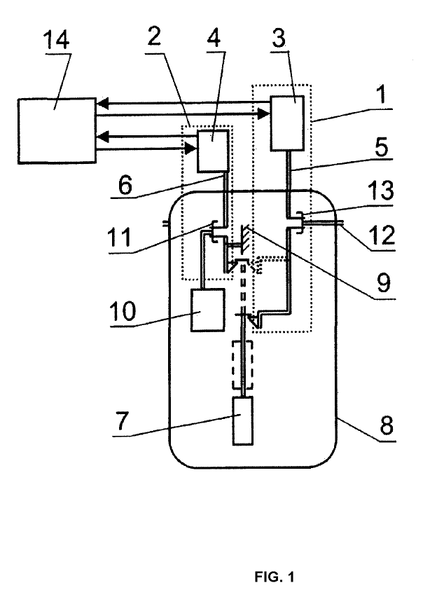

### DESCRIPTION OF PREFERRED EMBODIMENTS

The numbers in the drawing denote:
1—common actuator (limited by a chain of dots);
2—individual actuator (limited by a chain of dots);
3—motor of a common actuator;
4—motor of an individual actuator;
5—connection between a common actuator motor and an operating device;
6—connection between an individual actuator motor and an operating device;
7—operating device;
8—reactor shell;
9—fixed element;
10—two-position switch;
11—disengaging element for an individual actuator connection;
12—connector at the reactor shell;
13—disengaging element for a common actuator connection;
14—control panel.

The position of an operating device after movement is shown by dotted line. The chain of bold dots shows the position of a portion of the connection 5 after movement of the operating device 7.

The control system for a shell-type nuclear reactor comprises a set of technical means intended for limiting an increment rate in reactivity by the operating devices and for automatic shutdown of a nuclear reactor, wherein the set comprises the actuators 1, 2 with the motors 3, 4, the connections 5, 6 transmitting motion from the motors 3, 4 of the actuators 1, 2 to the operating devices 7, wherein the latter being disposed within the reactor shell 8 and the motors 3 and 4 being disposed outside the upper part of the reactor shell 8.

Within the reactor shell 8 the fixed elements 9 are arranged for the purposes of engaging and disengaging the operating devices 7, e.g., with the use of a latch, with the possibility of moving the operating devices 7 by the resultant of the forces continuously acting on the operating devices, e.g., by the gravity force of the operating devices 7, after disengagement toward a decrement in reactivity only. Each operating device 7 is provided with at least two actuators 1 and 2, one of which, namely the actuator 1, is common for all the operating devices 7 or for a group of operating devices 7 and moves the operating devices 7 toward an increment in reactivity up to engagement with the fixed elements 9 only alternatively, one by one, after the connection 5 of its motor 3 engages a selected operating device 7, and the other, namely the actuator 2, is individual for each operating device 7 and disengages the operating device 7 from the said fixed element 9 in any sequence relative to the other operating devices 7 by disengaging the connection 6 of its motor 4 with the engaging element of the operating device 7 from the said fixed element 9. The design of the mechanical elements of the connection 5 is analogous to the design of the mechanical elements of known manipulators used in “hot” chambers of nuclear power stations.

The said set of technical means is provided with two-position switches 10 which are arranged within the reactor shell 8 and have two fixed positions depending on the position of the control element of the switch 10 relative to the critical position corresponding to a critical value reached by one of the parameters defining the limits of the reactor safe operation. The design of the two-position switches 10 is analogous to that of known spring-loaded two-position switches used in lighting systems. The control elements of the two-position switches 10 are moved by devices analogous to mechanical parts of known parameter sensors, e.g., pressure gages, flow meters, level gages.

The connections 6 of the motors 4 of the individual actuators 2 with the engaging elements are provided with the controlled disengaging elements 11 that are arranged within the reactor shell 8 and made, e.g., as coupling elements serving to disengage the connections 6 for the purpose of moving the operating devices 7 toward a decrement in reactivity when the two-position switches 10 are in the position corresponding to the critical values reached by the parameters defining the limits of the reactor safe operation.

The reactor shell 8 has the upper part and the lower part which are connected along the connector 12. The connection 5 between the motors 3 of the common actuators 1 and the operating devices 7 are provided with disengaging elements 13 arranged within the reactor shell 8 near the connector 12 and made in the form of, e.g., coupling elements capable of disengaging the connection 5 when the connector 12 of the reactor shell 8 is disconnected.

The control elements of the two-position switches 10 are made with the possibility of their moving by the common actuator 1 after the connection 5 of its motor 3 engages with a selected control element only toward transferring the two-position switches 10 to the stop state corresponding to induced movement of the operating devices 7 toward a decrement in reactivity.

The operating devices 7 may be made in the form of rods containing isotopes with a big absorption cross-section and capable of longitudinally moving along the guide channels from one extreme position to the other without stopping in any intermediate position and without monitoring intermediate positions of the operating devices 7, the influence of each individual operating device 7 on reactivity being small. Each operating device 7 may be provided with electromagnetic sensors of the extreme upper position and the extreme lower position in the guide channel, which are analogous to known electromagnetic sensors for position of steel elements in a coolant.

The operating devices 7 may be arranged relative to the said fixed elements 9 of the reactor with the possibility for the operating devices 7 of moving by the gravity force or the buoyancy force only toward a decrement in reactivity after disengaging from the said fixed elements 9 of the reactor when the operating devices 7 are not engaged with the connection 5 of the motor 3 for the common actuator 1.

The element for engaging the connection 5 of the motor 3 of the common actuator 1 with the operating device 7 may be made in the form of the reactor coolant with the possibility of setting this coolant in motion by the common actuator 1 for the purpose of moving the operating device 7 toward an increment in reactivity up to engagement with a fixed element 9 of the reactor.

The two-position switches 10 with their control elements are made with the possibility of inducing movements of the operating devices 7 toward a decrement in reactivity when the following parameters reach their critical values: thermal elongation of the reactor fuel rods, and/or density of the reactor coolant, and/or corrosiveness of the reactor coolant.

The control element of the two-position switch 10, which acts when thermal elongation of the fuel rods reaches its critical value, may be made with the possibility of changing its position depending on a difference between the fuel rod length and the length of a reactor element having the temperature equal to that of the reactor coolant and made either of the material used for making the fuel rod casing or of a material having the thermal elongation coefficient lesser than that of the fuel rod casing.

The control element of a two-position switch 10, in order to act when the reactor coolant reaches its critical density, may be connected to a float located in a chamber filled with the reactor coolant having a temperature and a pressure corresponding to those of the coolant exiting the reactor core.

The control element of the two-position switch 10, in order to act when the reactor coolant reaches its critical corrosiveness value, may be connected to an element arranged in the reactor coolant and made of the material used for making the fuel rod casing, wherein the said element may be destructed under a set load due to corrosive wear.

The motors 3 and 4 are connected by electric connections with the control panel 14 of the control system.

In order to increase reactivity, according to a signal from the control panel 14, the motor 3 of the common actuator 1 moves the connection 5 which engages one of the operating devices 7 being in the lower position and moves that operating device 7 upward along the guide channel up to the point of engagement of the operating device 7 with a fixed element 9. According to a signal from the control panel 14, the motor 4 of the individual actuator 2 moves, through the connection 6, the latch that engages the operating device 7 with the fixed element 9. Then, the connection 5 disengages from the raised operating device 7 and may engage the next operating device 7 being in its lower position.

In order to decrease reactivity, according to a signal from the control panel 14, the motor 4 of the individual actuator 2 moves, through the connection 6, the latch that disengages the operating device 7 from the fixed element 9, then the operating device 7 moves down up to stop under the gravity force.

In a case of subversive control the control signals from the control panel 14 to the motors 3 and 4 of the actuators may be intended for violating the safe operation limits, including moving all the operating devices 7 toward an increment in reactivity subject to inhibition of back movement of the operating devices 7. In such a case, when the parameters defining safety of a nuclear reactor reach their critical values, the following occurs:
In the two-position switches 10 having the control elements changing their positions depending on a difference between the length of a fuel rod and the length of the test element of a nuclear reactor a critical thermal elongation of the fuel rods moves the said element to such a distance that it moves the two-position switch 10 to the stop state;
in the two-position switches 10 having the control elements changing their positions depending on a position of the float disposed in a chamber filled with a coolant due to a critical decrement in the density of the coolant the float lowers and transfers the two-position switch 10 to the stop state;
in the two-position switches 10 having an element failing due to critical corrosive wear the control element, after failure of the said element, transfers the two-position switch 10 to the stop state.

The transfer of the two-position switches 10 to the stop state leads to disengagement of the coupling connections 11. In the result, the operating devices 7 are disengaged from the fixed elements 9 and moved under the gravity force downward to their full stop, i.e., toward a decrement in reactivity. When the operating devices 7 that are not engaged with the common actuator 1 move downward simultaneously, a rate of decreasing reactivity will be much more greater than a rate of increasing reactivity by the common actuator 1 which may move the operating devices upward only alternatively, wherein in their upper position the operating devices will not be engaged with the fixed elements 9 and after disengaging from the connection 5 will also move downward to their full stop. Due to general decrement in reactivity the nuclear reactor will be shut down automatically, without violating the safe operation limits, in cases of violating the normal operation mode due to subversive control of the nuclear reactor having operable elements of the said set of technical means disposed within the reactor shell.

The two-position switches 10 are returned to their normal state as follows:
for the control elements of the two-position switches 10 having elements changing their positions depending on a difference between the length of the fuel rods and the length of the test elements—after the fuel rods are cooled to a pre-set temperature;
for the control elements of the two-position switches 10 having elements changing their positions depending on a position of the float in the chamber filled with the coolant—after the float raises due to an increment in the coolant density to a pre-set value;
for the control elements of the two-position switches 10 having elements failed due to critical corrosive wear—after the failed element is changed.

In order to check the operability of the elements in the said set of technical means that are disposed within the reactor shell, the common actuator 1 alternatively engages the connection 5 with the control elements 25 of the two-position switches 10. When the connection 5 moves the control element toward transferring the two-position switch 10 to its stop state the operating devices 7, which individual actuators 2 are connected to that two-position switch 10, should move down to their full stops, this process being monitored by the position sensors of the operating devices 7. In a case of a sufficient number of the two-position switches 10 a decrement in the nuclear reactor power, which is caused by movement of the operating devices 7 due to using one two-position switch 10, will not violate the normal operation mode of the reactor.

### INDUSTRIAL APPLICABILITY

The present invention may be used in nuclear power engineering for improving safety of nuclear power stations.

1. A control system for a shell-type nuclear reactor, comprising a set of technical means for limiting an increment rate in reactivity by operating devices and for automatically shutting down a nuclear reactor, wherein the said set of technical means comprises actuators provided with motors and connections which transmit the motion from the actuator motors to the operating devices, the latter being disposed within the reactor shell, CHARACTERIZED IN THAT within the reactor shell fixed elements are installed for the purposes of engaging and disengaging the operating devices in such a way that the operating devices become movable by the resultant of the forces continuously acting on the operating devices after their disengagement toward a decrement in reactivity only, each operating device is provided with at least two actuators one of which is common for all the operating devices or for a group of operating devices and moves the operating devices toward an increment in reactivity up to engagement with fixed elements only alternatively one by one after engagement of its motor connection with a selected operating device, and the other one is individual for each operating device and disengages the operating device from a said fixed element in any order relative to the other operating devices by disengaging the connection of its motor to the element engaging the operating device with the said fixed element, the said set of technical means is provided with two-position switches disposed within the reactor shell and having two fixed states depending on the position of the control element for the switch relative to a critical position corresponding to a critical value achieved by one of the parameters defining the safe operation limits for the reactor, e.g., thermal elongation of fuel rods of the reactor, the connections of the individual actuator motors to the engagement elements are provided with controlled disengagement elements, made, e.g., in the form of a coupling element, that are disposed within the reactor shell and capable of disengaging the connections for the purpose of moving operating devices toward a decrement in reactivity if the state of the two-position switches corresponds to critical values of the parameters defining the reactor safe operation limits, the connections of the common actuator motors to the operating devices are provided with disengagement elements, made, e.g., in the form of a coupling element, that are disposed within the reactor shell near the shell connector and capable of disengaging the connections when the reactor shell connector is disconnected, the control elements for the two-position switches are made with the possibility of moving the control elements by a common actuator, after the connection of the corresponding motor engages a selected control element, only to the side corresponding to an induced movement of the operating devices toward a decrement in reactivity.

2. A system according to claim 1, CHARACTERIZED IN THAT the operating devices are made in the form of rods influencing reactivity and being capable of longitudinally moving from one extreme position to the other without stopping in an intermediate position and without monitoring intermediate positions of the operating devices, the influence of each individual operating device on reactivity being small.

3. A system according to claim 1, CHARACTERIZED IN THAT the operating devices are arranged relative to the said fixed elements of a reactor with the possibility of being moved by the gravity force or the buoyancy force toward a decrement in reactivity only after being disengaged from the said fixed elements of a reactor if the operating devices are not engaged with the connection of the common actuator motor.

4. A system according to claim 1, CHARACTERIZED IN THAT an element engaging the connection of the common actuator motor with the operating device is made in the form of a reactor coolant with the possibility of setting said coolant into controlling motion by the common actuator for the purpose of moving an operating device toward an increment in reactivity up to engagement with a fixed element of the reactor.

5. A two-position switch for passive protection of a nuclear reactor, having two fixed states depending on a position of the switch control element relative to a critical position corresponding to a critical value reached by one of the parameters defining the reactor safe operation limits, CHARACTERIZED IN THAT the said control element is made so as to enable the two-position switch going from one fixed state to the other (acting) if the following parameters reach their critical values: thermal elongation of fuel rods of a nuclear reactor, and/or density of a reactor coolant, and/or corrosiveness of a reactor coolant.

6. A two-position switch according to claim 5, CHARACTERIZED IN THAT the control element of a two-position switch, in order to act at thermal elongation of a fuel rod at a critical value, is made with the possibility of changing its position depending on a difference between the length of a fuel rod and that of a reactor element having a temperature equal to that of a reactor coolant and made either of a material used for making the fuel rod casing, or of a material having the thermal elongation modulus lesser than that of the fuel rod casing.

7. A two-position switch according to claim 5, CHARACTERIZED IN THAT the control element of a two-position switch, in order to act when a reactor coolant reaches its critical density, is connected to a float arranged in a chamber filled with the reactor coolant having a temperature and a density corresponding to those of the coolant at the outlet of the reactor core.

8. A two-position switch according to claim 5, CHARACTERIZED IN THAT the control element of a two-position switch, in order to act when a reactor coolant reaches its critical corrosiveness, is connected to an element arranged in the reactor coolant and made of the material used for making the fuel rod casing in such a way that the said element may be destructed under a given load due to corrosive wear.
